(19) United States
(12) Patent Application Publication
(10) Pub. No.: US 2025/0209723 A1
(43) Pub. Date: Jun. 26, 2025

(54) System and Method for Low-precision Ray Tests

(71) Applicants: Advanced Micro Devices, Inc., Santa Clara, CA (US); ATI Technologies ULC, Markham (CA)

(72) Inventors: Andrew Erin Kensler, Seattle, WA (US); Sean Keely, Austin, TX (US); David William John Pankratz, Montreal (CA); Michael John Livesley, Edinburgh (GB); David Kirk McAllister, Holladay, UT (US)

(21) Appl. No.: 18/391,632

(22) Filed: Dec. 20, 2023

(51) Int. Cl. G06T 15/06

(52) U.S. Cl. CPC G06T 15/06; G06T 2210/21

(57) ABSTRACT

Systems and methods described herein use multiple reduced-precision intersection testers in parallel to determine candidate nodes to traverse in a wide BVH. Primitives are quantized to generate primitive packets, that are stored compactly in, with, or near a leaf node. At the leaves of the BVH, these intersection testers test a ray simultaneously against a plurality of triangles in the primitive packet to find candidate triangles that require full-precision intersection. Triangles or primitives that generate an inconclusive result during low-precision testing are retested using full-precision testers to definitively determine ray-triangle hits or misses. Testing the quantized triangles simultaneously using low-precision testers culls instances wherein the ray misses a box or a triangle that need not be tested using higher precision.

### BACKGROUND

### Description of the Related Art

When performing ray tracing during rendering to generate images, the level of precision used to perform computations can affect the quality and detail of the resulting image. There are several key areas where precision is a critical consideration in ray tracing. When tracing rays from the camera into a scene to determine what objects or surfaces they hit, the precision of these intersection tests affects the accuracy of the results. Higher precision can help reduce artifacts like “shadow acne” (small unwanted self-shadows on surfaces) and improve the overall visual fidelity. Further, the precision with which the rays' origins (camera positions) and directions (pixel positions on the image plane) are defined can affect the sharpness and clarity of the rendered image. Smoother camera movement and better-defined pixels contribute to improved image quality.

Ray tracing often involves calculations with floating-point numbers to represent positions, colors, and other attributes. The precision of these floating-point numbers can impact the accuracy of the simulation and the prevention of numerical errors or “floating-point artifacts.” In complex scenes with many reflections, refractions, and interactions between rays and surfaces, maintaining numerical stability is crucial to avoid visual glitches or inaccuracies in the final image. Ensuring precision throughout the calculations helps achieve numerical stability.

However, there is often a trade-off between precision and computational performance. Higher precision generally takes longer and demands more computational resources, including memory, use of various circuits, and power. Therefore, a balance between achieving a desired level of visual quality and optimizing rendering performance based on the hardware and rendering requirements is often desired.

In view of the above, improved systems and methods to achieve desirable computational performance during ray intersection testing are needed.

### BRIEF DESCRIPTION OF THE DRAWINGS

The advantages of the methods and mechanisms described herein may be better understood by referring to the following description in conjunction with the accompanying drawings, in which:

FIG. 1 is a block diagram of one implementation of a computing system.

FIG. 2 illustrates the details of the computing system.

FIG. 3 is an illustration of an intersection testing circuitry.

FIG. 4 illustrates a block diagram for quantizing triangles in a bounding volume hierarchy (BVH) using a triangle prefiltering node.

FIG. 5 illustrates exemplary bounds of a quantized triangle for ray intersection testing.

FIG. 6 illustrates one or more exemplary outcomes of a low-precision fixed-point ray-triangle intersection test.

FIG. 7 illustrates an exemplary method for ray triangle intersection testing for an acceleration structure.

### DETAILED DESCRIPTION OF IMPLEMENTATIONS

In the following description, numerous specific details are set forth to provide a thorough understanding of the methods and mechanisms presented herein. However, one having ordinary skill in the art should recognize that the various implementations may be practiced without these specific details. In some instances, well-known structures, components, signals, computer program instructions, and techniques have not been shown in detail to avoid obscuring the approaches described herein. It will be appreciated that for simplicity and clarity of illustration, elements shown in the figures have not necessarily been drawn to scale. For example, the dimensions of some of the elements may be exaggerated relative to other elements.

Systems, apparatuses, and methods for low-precision ray/triangle or ray/box testing are described. As described herein, a ray tracing system uses multiple reduced-precision intersection testers in parallel to determine candidate nodes to traverse in a relatively wide BVH. Geometric primitives within the BVH are quantized to generate prefilter nodes that are stored compactly at or near leaf nodes of the BVH. At the leaves of the BVH, reduced-precision intersection testers test a ray simultaneously against a plurality of triangles in the prefilter nodes to find candidate triangles that require full-precision intersection. Triangles or primitives that generate an inconclusive result during low-precision testing are retested using higher-precision testers to determine ray-triangle hits or misses. Testing the quantized triangles simultaneously (i.e., in parallel) using low-precision testers speeds culling of instances that do not require higher precision testing.

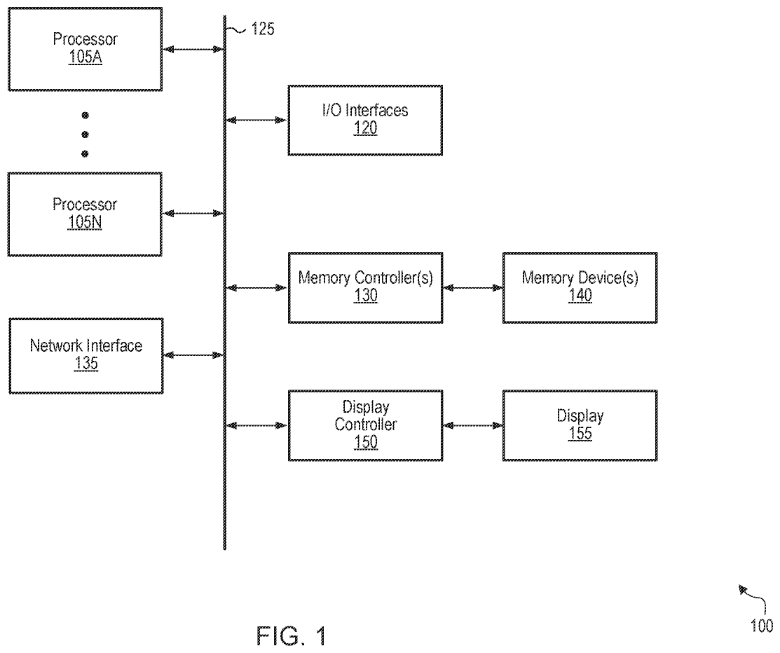

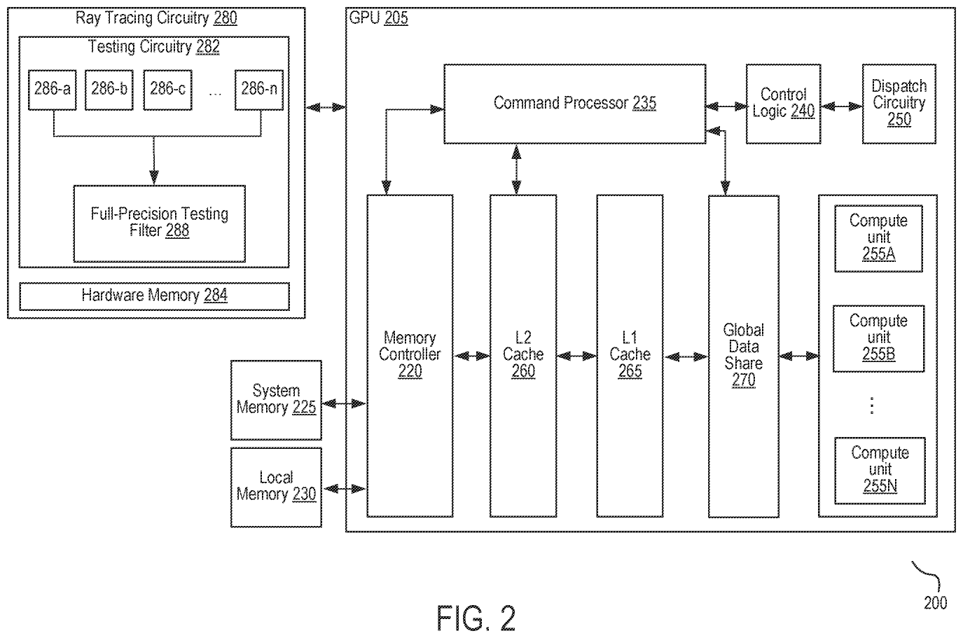

Referring now to FIG. 1, a block diagram of one implementation of a computing system 100 is shown. In an implementation, computing system 100 is configured to, amongst other functionalities, render a scene using ray tracing for creating highly realistic images. The computing unit 100 is configured to cast rays from a camera's viewpoint into a scene and trace the paths of these rays to determine how they interact with objects and light sources in the scene. Further, computing system 100 is configured to perform reduced-precision ray triangle or ray box intersection tests that complement full-precision tests to detect primitives that are intersected or missed by a given ray. These intersection tests are explained in further detail with respect to subsequent FIGS. 2-7.

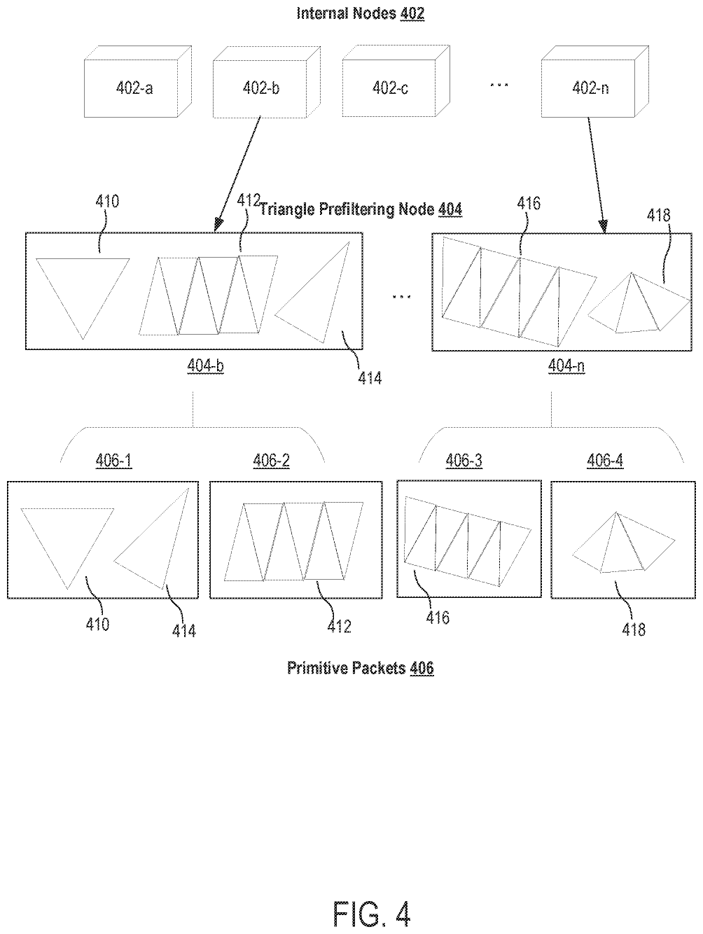

In one implementation, computing system 100 includes at least processors 105A-N, input/output (I/O) interfaces 120, bus 125, memory controller(s) 130, network interface 135, memory device(s) 140, display controller 150, and display 155. In other implementations, computing system 100 includes other components and/or computing system 100 is arranged differently. Processors 105A-N are representative of any number of processors which are included in system 100. In several implementations, one or more of processors 105A-N are configured to execute a plurality of instructions to perform functions as described with respect to FIGS. 4-9 herein.

In one implementation, processor 105A is a general purpose processor, such as a central processing unit (CPU). In one implementation, processor 105N is a data parallel processor with a highly parallel architecture. Data parallel processors include graphics processing units (GPUs), digital signal processors (DSPs), field programmable gate arrays (FPGAs), application specific integrated circuits (ASICs), and so forth. In some implementations, processors 105A-N include multiple data parallel processors. In one implementation, processor 105N is a GPU which provides pixels to display controller 150 to be driven to display 155.

Memory controller(s) 130 are representative of any number and type of memory controllers accessible by processors 105A-N. Memory controller(s) 130 are coupled to any number and type of memory devices(s) 140. Memory device(s) 140 are representative of any number and type of memory devices. For example, the type of memory in memory device(s) 140 includes Dynamic Random Access Memory (DRAM), Static Random Access Memory (SRAM), NAND Flash memory, NOR flash memory, Ferroelectric Random Access Memory (FeRAM), or others.

I/O interfaces 120 are representative of any number and type of I/O interfaces (e.g., peripheral component interconnect (PCI) bus, PCI-Extended (PCI-X), PCIE (PCI Express) bus, gigabit Ethernet (GBE) bus, universal serial bus (USB)). Various types of peripheral devices (not shown) are coupled to I/O interfaces 120. Such peripheral devices include (but are not limited to) displays, keyboards, mice, printers, scanners, joysticks or other types of game controllers, media recording devices, external storage devices, network interface cards, and so forth. Network interface 135 is used to receive and send network messages across a network.

In various implementations, computing system 100 is a computer, laptop, mobile device, game console, server, streaming device, wearable device, or any of various other types of computing systems or devices. It is noted that the number of components of computing system 100 varies from implementation to implementation. For example, in other implementations, there are more or fewer of each component than the number shown in FIG. 1. It is also noted that in other implementations, computing system 100 includes other components not shown in FIG. 1. Additionally, in other implementations, computing system 100 is structured in other ways than shown in FIG. 1.

As used hereinafter “intersection testers,” “intersection testing filters,” or simply “testers” refer to specialized hardware components that include circuitry configured to perform ray tracing calculations in graphics rendering. In various implementations, these components include ray tracing (RT) cores and tensor cores. RT cores include dedicated hardware circuitry specifically designed for ray tracing calculations. They are responsible for performing ray-object intersection tests for determining how light interacts with objects in a scene. Further, tensor cores include specialized hardware used to accelerate certain aspects of ray tracing and other machine learning workloads. In implementations described herein, lower-precision (or reduced precision) intersection testing filters are configured to perform ray intersection tests with quantized (reduced) precision objects, such as triangles. Similarly, higher-precision intersection testing filters are configured to perform ray intersection tests with higher (or full) precision computations.

Turning now to FIG. 2, a block diagram of another implementation of a computing system 200 is shown. In one implementation, system 200 includes GPU 205, system memory 225, and local memory 230. System 200 also includes other components which are not shown to avoid obscuring the figure. GPU 205 includes at least command processor 235, control logic 240, dispatch unit 250, compute units 255A-N, memory controller 220, global data share 270, level one (L1) cache 265, and level two (L2) cache 260. In other implementations, GPU 205 includes other components, omits one or more of the illustrated components, has multiple instances of a component even if only one instance is shown in FIG. 2, and/or is organized in other suitable manners. In one implementation, the circuitry of GPU 205 is included in processor 105N (of FIG. 1). System 200 further includes ray tracing circuitry 280 at least including a testing circuitry 282 and memory 284. As shown in the figure, ray tracing circuitry 280 is independent of the GPU 205, however in alternate implementations, ray tracing circuitry 280 can be internal to the GPU 205 or otherwise form a part of the GPU 205. Such implementations are contemplated.

In an implementation, the testing circuitry 282 is configured to test a ray against primitives included within a bounding volume hierarchy (BVH). The testing circuitry 282 further comprises a plurality of low-precision (or “reduced-precision”) testing filters 286a-286n and a higher precision (full-precision) testing filter 288. It is noted that although only a single full-precision testing filter 288 is shown for the sake of brevity, in various implementations multiple full-precision filters can be implemented based on application specifics. Such implementations are contemplated.

In various implementations, computing system 200 executes any of various types of software applications. As part of executing a given software application, a host CPU (not shown) of computing system 200 launches kernels to be performed on GPU 205. Command processor 235 receives kernels from the host CPU and uses dispatch unit 250 to issue corresponding wavefronts to compute units 255A-N. Wavefronts executing on compute units 255A-N read and write data to global data share 270, L1 cache 265, and L2 cache 260 within GPU 205. Although not shown in FIG. 2, in one implementation, compute units 255A-N also include one or more caches and/or local memories within each compute unit 255A-N. As described below, certain types of circuits are referred to as “units” (e.g., a decode unit, compute unit, an arithmetic logic unit, functional unit, memory management unit, etc.). Accordingly, the term “unit” or “units” also refers to circuits or circuitry unless otherwise indicated.

In one implementation, ray tracing circuitry 280 is configured to perform ray tracing to render a three dimensions (3D) scene by using an acceleration structure (such as a BVH) to perform ray tracing operations, including testing for intersection between light rays and objects in a scene geometry. In some implementations, much of the work involved in ray tracing is performed by programmable shader programs, executed on the compute units 255A-N, as described below. In an implementation, ray tracing circuitry 280 as described herein refers to specialized hardware components or dedicated processing units designed to accelerate ray tracing, a rendering technique used in computer graphics to generate highly realistic images by simulating the interaction of light and objects in a scene.

In one implementation, during a ray intersection test, computations are performed to determine if a ray originating at a given (originating) source intersects with a geometric primitive (e.g., triangles, implicit surfaces, or complex geometric objects). When an intersection is identified, a distance from the origin of the ray to the intersection is calculated. In an implementation, ray tracing tests use a spatial representation of nodes, such as those in the BVH. In the BVH, each non-leaf node may represent an axis-aligned bounding box that bounds the geometry of all children of that node. In one example, a root node represents the maximum volume over which the ray intersection test is performed. Leaf nodes represent triangles or other geometric primitives on which ray intersection tests are performed (as described in detail in FIG. 4).

In an implementation, when a given BVH is built, ray tracing circuitry 280 is configured to pre-quantize a group of triangles and store them compactly (e.g., in a compressed format) within a given node of the BVH (e.g., as prefilter nodes generated between the internal nodes and leaf nodes of the BVH). The pre-quantized group of triangles can be tested simultaneously against a single ray. In one implementation, simultaneous testing of the pre-quantized group is performed using low-precision testing filters 286 in parallel. These tests are used by shader programs running on the compute units 255A-N to generate images using ray tracing accelerated by the optimized BVH. The updated images are then queued for display by command processor 235. In one implementation, with pre-quantization of the triangles, the ray tracing circuitry 280 does not need to perform full-precision testing of a triangle if an intersection test using low-precision testing has indicated that none of the pre-quantized triangles could be hit by a given ray. If low precision testing is inconclusive for one or more of the triangles, then a higher precision test is performed for only those one or more triangles. By reducing the number of full precision tests that are performed, computational efficiency of the system can be improved.

In an implementation, to pre-quantize the group of triangles, the ray tracing circuitry 280 is configured to compute bounds around the group of triangles and round a minimum corner of the resultant bounding box (e.g., down to “bfloat16” (16 bit floating point) values for compactness. Further, in an implementation, a maximum corner of the bounding box is rounded up such that the bounding box has a power-of-two size in each dimension. The power-of-two box dimensions can provide computational benefits in that the bounding box can be compactly stored, e.g., by only storing the bfloat16 value of a minimum corner and exponent byte of the power-of-two box dimensions. Further, processing efficiency of the ray tracing circuitry 280 can be improved by quantizing the triangles, since multiplication and division of a floating-point value by a power-of-two can be simply performed by adding or subtracting the floating-point values from the exponent contained within the floating-point value. Likewise, multiplication or division of an integer by a power-of-two can also be done by shifting the bits to the left or right. In one implementation, data associated with the pre-quantized and full-precision triangles is stored in memory 284.

In operation, when intersection tests are performed, the ray tracing circuitry 280 tests a given ray against each quantized triangle simultaneously using the plurality of low-precision testing filters 286 in parallel. Testing the quantized triangles simultaneously using the low-precision testing filters 286 (e.g., based on a fixed-point arithmetic), the ray tracing circuitry 280 can cull instances where a ray misses a triangle. This eliminates the need to test all instances using a higher (e.g., full) precision test. Further, in some implementations, for a wider BVH having shorter traversal paths, the low-precision intersection tests can be used by ray tracing circuitry 280 to determine which child nodes of an interior node of the BVH should be visited. For example, in some applications, compactly-stored pre-quantized triangles can be used as an interior node of the BVH, such that there are no corresponding full-precision triangles to be tested. Further, which of the quantized triangles are hit by the ray is determined using the low-precision testing filters 286, which in turn determines which of the nodes in the BVH below the interior node should be visited.

As used herein, a “wide” BVH refers to a specific type of acceleration data structure used in ray tracing and computer graphics to improve the efficiency of ray-object intersection tests. A BVH is a hierarchical organization of bounding volumes (usually axis-aligned bounding boxes or spheres) that encompass different parts of a 3D scene's geometry. A “wide” BVH refers to a BVH with each node in the hierarchy encompassing a relatively large portion of the scene geometry compared to traditional or “narrow” BVHs. The wide BVH nodes have broader bounding volumes that may span multiple objects or regions of the scene. Because of their wider coverage, wide BVHs reduce the depth of the hierarchy compared to narrow BVHs. This means that fewer traversal steps are required to find the closest intersection with a ray.

For the quantized triangles or boxes, a low-precision intersection test can filter the list of triangles or boxes prior to higher or “full” precision intersection testing. Since hardware requirements for full-precision intersection testing are significant, generating wide BVHs as described herein and using multiple low-precision intersection test filters (such as filters 286 in parallel)_can reduce the number of higher precision tests needed. In doing so, computational resources (and potentially silicon space) can be saved and the efficiency of the ray tracing circuitry 280 may be enhanced.

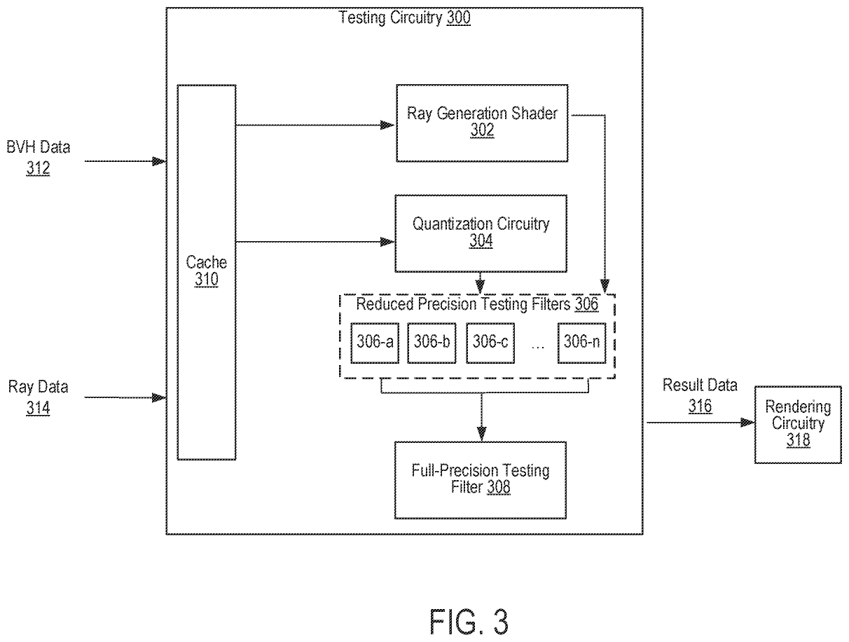

FIG. 3 illustrates an exemplary ray intersection testing circuitry (“testing circuitry 300”). As described above, ray tracing circuitry, e.g., ray tracing circuitry 280 of FIG. 2, includes circuitry to test intersection of primitives of a BVH with a given ray. In an implementation, testing circuitry 300 includes a ray generation shader 302, quantization circuitry 304, a plurality of reduced-precision testing filters/circuits 306 (or “low-precision testers 306”), at least one full-precision testing filter/circuit 308, and cache memory 310.

In one implementation, the testing circuitry receives BVH data 312 associated with a given BVH, the nodes for which are to be tested against a ray. The BVH data 312, in one example, is received from a BVH builder (not shown), such as a hardware accelerator or a software program executed by a driver or otherwise. In an implementation, the BVH data 312 includes at least spatial data structures to efficiently organize 3D scene data. These data structures divide the scene into smaller bounding volumes. In an example, a BVH builder may employ spatial partitioning algorithms to efficiently divide a scene into smaller bounding volumes, using Surface Area Heuristic (SAH) or middle-split methods. In an implementation, the BVH data 312 is stored in cache memory 310 such that it is accessible by one or more components of the testing circuitry 300. In one instance, quantization circuitry 304 is configured to quantize and store primitives identified by the BVH in a compressed format.

In an implementation, the quantization circuitry 304 is configured to convert floating-point data representing the vertices of triangles into reduced-precision formats, such as fixed-point or integer representations. The quantization circuitry 304 receives the vertex data for the triangles as input (e.g., included in BVH data 312), including data in floating-point format, represented by three-dimensional vectors for each vertex. The quantization circuitry 304 performs the conversion of floating-point vertex data to fixed-point or integer representation. Fixed-point formats represent fractional values using integers, and integer formats store values directly as integers. The quantization process includes scaling the vertex coordinates to fit within a desired range and then rounding values to a quantization resolution, e.g., a smallest distinguishable increment or unit in which a continuous range of values can be divided. In an implementation, to ensure that quantization error is acceptable during ray tracing, the quantization circuitry 304 includes one or more error analysis mechanisms to determine the impact of quantization on the accuracy of ray-object intersection tests during ray tracing.

The quantization circuitry 304 outputs quantized vertex data based on processing input BVH data 312, and the output data is stored in cache memory 310 or provided to the ray tracing pipeline for further processing. During ray-object intersection tests, the quantized vertex data may need to be converted back to floating-point format for more accurate calculations. The quantization circuitry 304, for example, can include inverse quantization logic to handle this conversion. In various implementations, the quantization circuitry 304 is configured to estimate the quantization error and control the quantization parameters dynamically based on scene complexity or other factors.

In one implementation, the testing circuitry 300 further receives ray data 314 to generate rays that are to be tested against a given quantized primitive in the BVH. In an example, the ray data 314 can be received from a GPU, such as GPU 205 described in FIG. 2, and stored in cache memory 310 to be accessed by ray generation shader 302. In an implementation, the ray generation shader 302 is a starting point of the ray tracing pipeline. The ray generation shader 302 is configured to generate primary rays (also known as camera rays or eye rays) that originate from a camera and traverse a scene. For each pixel on the screen, the ray generation shader 302 calculates the corresponding ray direction based on the camera properties (e.g., field of view, perspective, etc.), and sets initial ray parameters like ray origin, direction, and any additional payload data needed for shading.

In an implementation, ray generation shader 302 generates rays using backwards ray tracing. In backwards ray tracing, the ray generation shader 302 generates a ray having an origin at the point of the camera. The point at which the ray intersects a plane defined to correspond to the screen defines the pixel on the screen whose color the ray is being used to determine. If the ray hits an object, that pixel is “colored” based on the result of the closest hit. If the ray does not hit an object, the pixel is colored based on a miss result. In some implementations, additional rays can be generated and traced to determine the pixel color, e.g., reflection, refraction, or shadow rays.

In an implementation, one or more rays generated by the ray generation shader 302 is tested simultaneously against quantized primitives using the reduced-precision testing filters 306 (low-precision testers 306). These low-precision testers 306 include ‘n’ individual low-precision testers, 306a-n, where n is a positive integer. In one implementation, the value of n is between 8 to 16. The low-precision testers 306 operate in parallel and each tester tests one ray against a BVH leaf with a plurality of triangles at any given time during the intersection testing. For example, each group of low-precision testers 306 can test a ray against 8 to 16 triangles at once. In instances where a leaf node includes more triangles to test than the number of low-precision testers 306, the testing is performed by iterating through the leaf in batches.

In one implementation, full-precision testing filter 308 (or full-precision tester 308) is used in cases where inconclusive hit or miss results are identified when testing using low-precision filters 306. The full-precision tester 308, in one example, acts as a “second layer” of intersection testing, i.e., to retest triangles against a given ray for which the first test (using low-precision testers 306) did not yield a conclusive result. In an implementation, in cases where the low-precision tester 306 is able to definitively rule out any possibility of the ray intersecting the triangle, full-precision testing is not required. For example, when a quantized triangle is projected to a 2D plane and the ray intersects that plane outside of the bounds of the error induced by the quantization plus any error induced by the reduced-precision arithmetic, no more intersection testing may be required.

In another implementation, another instance where full-precision testing can be avoided is when a given low-precision tester 306 determines that the bounds of the error lie entirely within the quantized triangle, and so a ray must definitively hit the triangle, as long as one or more ray parameters (e.g., t-value) during the intersection lies within the ray's interval. For example, if the intersection of the ray with an AABB containing the triangle is fully within the ray interval, the ray definitively hits the triangle. Again, in cases such as these, full-precision testing is not required since there is an intersection (such as for opaque geometry with shadow rays).

In one implementation, the result of intersection tests, i.e., tests performed by low-precision testers 306 and second precision testers 308 (whenever called upon) can be transmitted as result data 316 to a rendering circuitry 318. In an example, the result data 316 includes at least a data structure, such as a bit mask, used to represent an intersection status of a ray with various triangles. The bit mask, in an example, is a binary sequence where each bit corresponds to a specific triangle being intersected or missed. Bit masks are initially set to 0 for all triangles and are set to 1 corresponding to triangles that are hit by the ray. In an implementation, if a ray intersection against a given triangle yields a definitive result during low-precision testing, a corresponding bit mask may be set to 1. For all triangles for which inconclusive results are generated, the bit masks continue to be set at 0 until retesting of these triangles is done by the full-precision tester 308. The bit mask value can then be modified to 1 in case of a hit or kept 0 in case of a miss.

In an implementation, the rendering circuitry 318 can include specialized hardware components and processing units designed to accelerate the computation of ray-traced images in real-time or high-performance rendering applications, e.g., using the result data 316. The rendering circuitry 318 can further include subcomponents such as texture mapping circuitry, framebuffers, rasterizers, and the like.

In various implementations, pre-quantizing triangles, grouping quantized triangles into leaf nodes, and simultaneously testing the triangles against a single ray using the low-precision testers 306, can essentially render the BVH to be shallow and thereby reduce the number of BVH traversal steps required. By comparison, conventional hardware may only be configured to test one ray against either a single triangle at a time, or against an adjoining pair of triangles at a time. Further, performing these computations with full-precision can be computationally expensive and may consume a significant amount of software resources such as processing power and memory, as well as hardware resources such as electrical power and silicon area. On the other hand, the testing circuitry 300 may only test triangles using full-precision tester 308, in cases where inconclusive results are provided by the low-precision tester 306. This in turn increases computational efficiency and the speed of testing the primitives against generated rays.

In one or more implementations, quantization circuitry 304 includes specialized hardware for quantization of BVH primitives involving representing the geometric information of the objects in a BVH using discrete values instead of continuous floating-point numbers. In an implementation, functionalities of the quantization circuitry 304, as described herein, can also be performed by a software program, e.g., executing in a GPU driver (not shown). Other implementations are contemplated.

Turning now to FIG. 4, a block diagram illustrating pre-quantization of triangles using triangle prefiltering nodes is described. In an implementation, using triangle filtering nodes, a quantization circuitry (e.g., quantization circuitry 304 described in FIG. 3) is able to quantize and group triangles as primitive packets in leaf nodes. As depicted in the figure, multiple triangle prefiltering nodes 404-a to 404-n are generated between internal nodes 402 and leaf nodes 408 of a given acceleration structure (such as a bounding volume hierarchy). In an implementation, the triangle prefiltering nodes are generated by the quantization circuitry to filter out triangles (both individual triangles and group of triangles), and create primitive packets 406. In one implementation, primitives from internal nodes 402 can be quantized to generate the prefilter nodes 404. Further, the full-precision primitives can be stored as primitive packets 406. Access to the primitive packets 406, for full-precision intersection can be conditional on inconclusive results from low-precision testing of the prefilter nodes 404. In one implementation, the prefilter nodes 404 and the primitive packets 406, cumulatively form the leaf nodes of the BVH, in that a given a branch of the BVH can be replaced by the prefilter nodes 404 and primitive packets 406 and together a testing circuitry (e.g., testing circuitry 300) performs primitive intersection testing for the BVH.

In another implementation, the prefilter nodes 404 are generated as a last layer of the internal nodes 402. In such a case, the testing circuitry stops testing after the prefilter nodes 404 are tested if conclusive results for such testing are ascertained. That is, for nodes providing conclusive testing results, the testing circuitry need not continue to test the primitive packets 406. More specifically, low-precision intersection is performed by the low-precision testers on the prefiltering nodes 404, while the full-precision intersection testing is done by the full-precision intersection testers on the primitive packets 406 (each time low-precision testers generate an inconclusive result).

As shown in the figure, the internal nodes 402 include internal nodes 402-a to 402-n. In one implementation, each internal node 402 corresponds to a bounding volume that encloses its child nodes (either internal nodes or leaf nodes with triangles). For instance, internal node 402-b includes individual triangles 410 and 414 and a set of overlapping triangles 412. Further, internal node 402-n includes overlapping triangle sets 416 and 418. Other internal nodes can similarly include triangles and triangle sets. In an implementation, the quantization circuitry generates a triangle prefiltering node 404-b encompassing the individual triangles 410 and 414 and the overlapping triangle 412 corresponding to the internal node 402-b. Similarly, a prefiltering node 404-n is generated corresponding to internal node 402-n, that includes overlapping triangles 416 and 418.

In an implementation, the quantization circuitry quantizes individual triangles and overlapping triangles corresponding to a prefiltering node and stores them compactly in a BVH node, e.g., as primitive packets in a leaf node. For example, from triangle filtering node 404-b, primitive packets 406-1 and 406-2 are generated, where packet 406-1 includes individual triangles 410 and 414 and packet 406-2 includes overlapping triangles 412. Further, primitive packets 406-3 and 406-4 are generated corresponding to triangle prefiltering node 404-n, such that packet 406-3 includes overlapping triangle set 416 and packet 406-4 includes overlapping triangle set 418. It is noted that objects other than triangles could also be filtered using methods described herein, and such implementations are contemplated.

In one implementation, in order to pre-quantize the group of triangles in a leaf, i.e., to generate a primitive packet 406, the quantization circuitry computes the bounds around each group of triangles in the leaf node, and rounds a minimum corner of the resultant bounding box down to bfloat16 values. Further, the maximum corner of the bounding box is rounded such that the box has a power-of-two size in each dimension (thereby letting the quantization circuitry store the box size as just the power, or exponent, or other suitable compact integer). Once the bounding box is optimized, the node is stored in the BVH along with the position of the box, and quantized triangle vertex coordinates (quantized relative to the bounding box) for all of the triangles grouped together within a given leaf node.

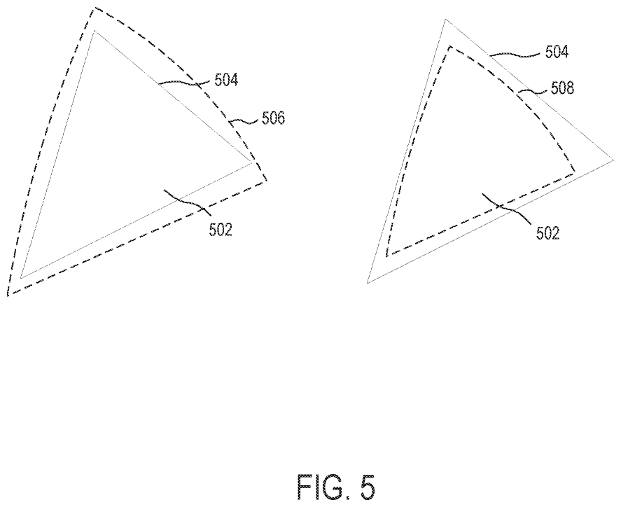

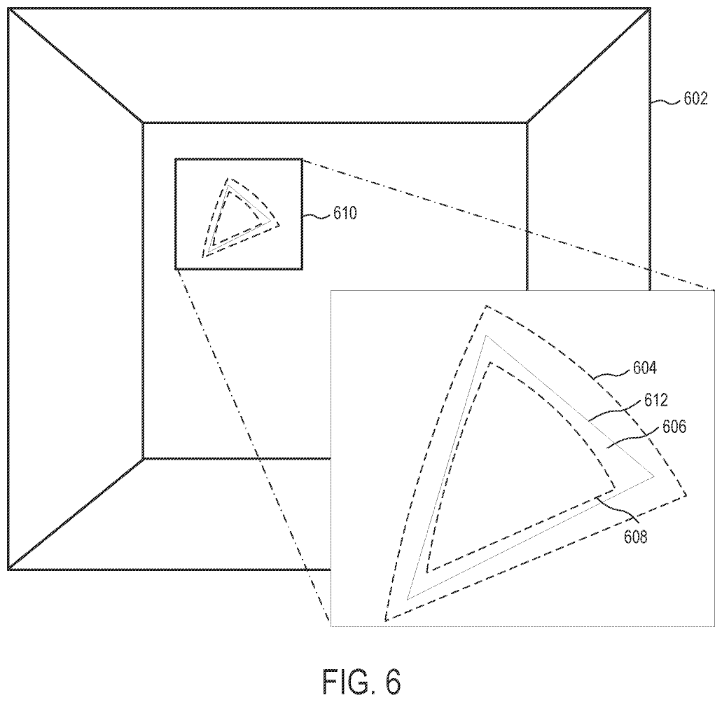

In one implementation, by pre-quantizing the triangles, the testing circuitry does not need to fetch full-precision triangle data at all if testing the quantized triangles can show that none of these triangles could actually be hit by a ray. In another implementation, only a subset of the full-precision triangle data may be fetched, e.g., associated with quantized triangles for which intersection testing generates inconclusive results. Intersection tests with various possible results are further described with regards to FIGS. 5 and 6.

Turning now to FIG. 5, exemplary outcomes for a low-precision ray-triangle intersection test are described. In an implementation, a plurality of reduced-precision testing filters (such as those described in FIG. 3) simultaneously test a given ray against multiple quantized triangles stored in a leaf node of a BVH. One such quantized triangle 502 is shown in FIG. 5, having a precise boundary 504. It is noted that although the description of FIG. 5 is based on ray intersections with triangles, other differently shaped objects can be tested in a similar manner. Such implementations are contemplated.

The lefthand side of the figure shows an outer bound 506 of the triangle 502 and the righthand of the figure shows inner bound 508 of the triangle 502. In an implementation, the outer bound 506 and inner bound 508 for the triangle 502 can be generated by the ray tracing circuitry by plotting the triangle 502 to a 2D plane such that the outer bound 506 is the area generated based on an error induced by the quantization of the triangle 502 plus any error induced by the fixed-arithmetic of the low-precision tester used for testing. Further, the inner bound area 508 for the triangle 502 is identified based on a determination that the bounds of the error lie entirely within the quantized triangle 502.

In an implementation, when intersection testing a ray against the triangle 502, a low-precision tester is able to generate a definite miss result responsive to the ray intersecting the 2D plane outside of the outer bound 506. No further processing of the ray against that triangle is required in case of a definite miss results and hence a full-precision tester is not engaged. Further, a low-precision tester is able to generate a definite hit result responsive to the ray hitting the inner bound 508 as long as the t-value of the intersection lies within the ray's interval. In an implementation, the ray tracing circuitry determines that the t-value of the intersection lies within the ray's interval by determining that the intersection of the ray with an AABB containing the triangle 502 is fully within the ray interval. Again, no further processing for the ray against the triangle 502 is required in such a case, provided that only a hit/miss determination for shadows is sufficient, or provided that approximate t-values and barycentric coordinates are sufficient. In some implementations, further processing may be required for inconclusive hit/miss determinations for shadows or t-values and barycentric coordinates have not been adequately approximated.

For all triangles for which the intersection testing generates an inconclusive result, a full-precision tester can be engaged to retest the ray against these triangles. For example, a ray intersecting the triangle 502 between boundary 504 and inner bound 508 can be a potential hit and for such a result the triangle is retested against the ray to definitely determine whether the ray intersects the triangle 502. Similarly, if the ray intersects the triangle 502 between boundary 504 and outer bound 506, the ray may potentially miss and for such a result the triangle 502 is retested against the ray using the full-precision tester.

In various implementations, quantizing the triangles to be tested and determining respective inner and outer bounds for each triangles facilitates simultaneous and parallel testing of the triangles, e.g., using low-precision testing filters as a first pass and retesting triangles with inconclusive results using higher or full-precision testing filters. This way, the ray tracing circuitry can more effectively cull instances where a ray misses a triangle, than what is possible when only performing conventional bounding volume intersection testing. Further, in some implementations, for a wide BVH having shorter traversal paths, the low-precision intersection tests can be used by ray tracing circuitry to rapidly determine which child nodes of an interior node of the BVH should be visited.

Turning now to FIG. 6, one or more exemplary outcomes of a low-precision fixed-point ray-triangle intersection test are described. In an implementation, a triangle 606 undergoing intersection test against a ray can be projected onto a 2D plane and a low-precision tester is used as a first pass to test whether the ray intersects the triangle or misses it. Whether the ray intersects or misses the triangle is ascertained by determining a point of intersection of the ray with the 2D plane. In one implementation, the low-precision testers used for the intersection testing are based on fixed-point arithmetic rather than the floating-point arithmetic used by conventional full-precision testers. The low-precision testers perform intersection tests using integer arithmetic, such that each quanta or step in the fixed-point arithmetic represents a fraction of a range. For example, if the value of quanta given by “Q” equals 10, each increment of the fixed-point value represents a step of 1/(2\hat{ }10) or 1/1024.

In one implementation, a quantization box 602 is built around the triangle 606. The quantization box 602, in one example, is a region in 2D or 3D space that contains a set of data values. These values can be identifiers for attributes such as color, density, or other properties associated with pixels in a volume dataset. In one implementation, the quantization box 602 is built to map continuous data values for triangle 606 to a limited set of discrete values. In one example, the quantization box 602 is divided into 2^{Q} slices in each dimension and the coordinates of the triangle 606 are rounded off to the centers of those slices. That is, a 2^{Q}×2^{Q}×2^{Q} grid is overlayed over the quantization box 606 and the coordinates of the triangle 606 are snapped to the cells. Snapping coordinates to cells herein refers to a process of aligning or moving the triangle's vertices, edges, or other elements to specific, discrete positions or increments within the quantization box 602. In one implementation, in a grid environment, snapping coordinates to the grid ensures that objects and elements are aligned to the gridlines or the centers between gridlines.

Generating the quantization box 602 and overlaying the quantization box 602 with the grid advantageously enables an intersection testing circuitry to perform tests using arithmetic with just small Q-bit integer values (or slightly larger, e.g., Q+3 bit values). By comparison, conventional testers use single-precision floating point arithmetic that perform computations on 23-bit mantissas and need additional computational resources for 8-bit exponents, sign bits, Not a Number (NaN), denormalized numbers, etc. Using fixed-point circuitry for testing allows for much smaller arithmetic logical unit (ALU) circuitry.

As depicted in the figure, outer bounds and inner bounds for the triangle 606 are computed, e.g., based on the error introduced by quantizing the triangle (as described in FIG. 4) plus the error induced owing to the low-precision testing of the triangle 606 having a precise boundary 612. The outer bounds 604 and inner bounds 608 and the area therebetween is shown within box 610 which has been enlarged for clarity. In one implementation, low-precision testers simultaneously test a ray against multiple triangles similar to the triangle 606 to determine whether a conclusive hit or miss result is generated. In an example, for triangle 606 a conclusive miss result is ascertained if the low-precision tester determines that the ray intersects the plane anywhere outside of the outer bounds 604 or intersects the plane outside of the quantization box 602 itself. Similarly, 606 a conclusive hit result is ascertained if the low-precision tester determines that the ray intersects the plane anywhere inside the inner bounds 608 (as long as the t-value range for an enclosing box lies within between a predetermined range of t-values, identified using the ray interval).

In one implementation, if an inconclusive result is obtained for the ray, i.e., if the ray intersects the plane anywhere between the inner bounds 608 and the outer bounds 604, the ray is retested against the triangle using a full-precision tester. The full-precision tester, in one example, acts as a second pass for results that are inconclusive. The full-precision testers can use a floating-point circuitry to test the ray against triangles generating inconclusive results, to precisely ascertain whether the ray intersects a given triangle or not.

In an implementation, in order to determine a given point in the triangle 606 that is intersected by the ray (i.e., for conclusive hits), a set of three scalar values used to represent a point within the triangle 606 are computed. Further, a ray tracing circuitry converts these scalar values from fixed-point to floating-point (i.e., reduced-precision to full-precision) and normalizes the values to compute approximate barycentric coordinates for the triangle 606. In another implementation, the t-value for the ray can be computed using the barycentric coordinates. A sum of the barycentric coordinates is generated and used to find the weighted average of the triangle vertices.

For example, when the triangle vertices are at coordinates P0, P1, and P2, and the three scalars for the edge test are given by e0, e1, and e2, the edge test values are normalized to get the barycentric coordinates, u, v, and w by the following:

$$u = e 0 / ( e 0 + e 1 + e 2 ) \\ v = e 1 / ( e 0 + e 1 + e 2 ) \\ w = e 2 / ( e 0 + e 1 + e 2 ) .$$

The hit point “H” can then be computed, as the weighted average of P0, P1, P2 by the using the barycentric coordinate values, as the weights, e.g., by the following:

$$H = P 0 * u + P 1 * v + P 2 * w ,$$

or equivalently,

$$H = P 0 * u + P 1 * v + P 2 * ( 1 - w ) .$$

Now, the approximate hit point, H, can be projected onto the ray to for calculating the approximate t-value, t, such that approximately:

O+t*D=H, where O is the ray origin and D is the ray direction. The projection that solves for this is given by:
t=dot (H−O, D)/length (D), where dot is the dot-product function and the length is the vector length function.
Other implementations for approximating t-values and barycentric coordinates are contemplated.

In one implementation, a low-precision test where a guaranteed or definitive miss result is obtained can be used as a standalone test for accelerating ray tracing procedures, whenever full-precision t-values and/or barycentric coordinates are required. That is, instances when a guaranteed or definitive miss result is obtained may need no further testing by a full-precision testing in situations where t-values and barycentric coordinates are not required. Further, in another implementation, a “combination” of low-precision test and full-precision tests, e.g., when low-precision tests produce an inconclusive hit or miss result, may be used in specific applications such as accelerating shadow rays, line-of-sight, or physics checks. That is the combination testing can be used where accurate hit or miss determinations are needed but t-values or barycentric coordinate information may not be needed.

For instance, in one implementation, a low-precision test where a guaranteed or definitive miss result is obtained can be used as a standalone test for accelerating ray tracing procedures, whenever full-precision t-value and/or barycentric coordinates are required. That is, instances when a guaranteed or definitive miss result is obtained may need no further testing by a full-precision testing in situations where t-values and barycentric coordinates are not required. That is, in cases where full-precision t-values and barycentric coordinates are not required, a definitive miss result can mean that a full-precision intersection testing would also determine a miss, and therefore no meaningful t-value or barycentric coordinate can be produced.

However, depending on application requirements, in cases where full-precision t-values and/or barycentric are needed, and an inconclusive result or a definitive hit result (i.e., any result other than a definitive miss) is obtained, then the ray is retested against the primitive with the full-precision tester. This is, to compute the full-precision t-value and/or barycentric as a biproduct, full-precision testing may still be required even when a definitive hit result is obtained. On the other hand, when approximate t-values and/or barycentric are required (or these are not required at all), then the ray may only need to be retested against the primitive using the full-precision tester only if an inconclusive result is obtained (i.e., no definitive hit or miss result is obtained).

In one implementation, stand-alone low-precision test may be used for coarse level-of-detail cases, e.g., where an object is tiny, or far off in the distance (and so is only a handful of pixels in the image), or otherwise may be rendered crudely. In such cases, t-values and barycentric coordinates can be calculated as described above, and the full-precision testing can be entirely avoided by using the low-precision test results as the only parameter in the calculation. Other implementations of standalone and combination testing are possible and are contemplated.

In one or more implementations, generating wider and shallower BVH enables compact low-precision testers for testing a ray against multiple primitives simultaneously that can advantageously enhance a conventional hardware ray tracing system. Further, significant reduction in bandwidth consumption can be realized by culling instances where a ray misses the primitive, than what is possible by only performing bounding volume intersection testing. The use of multiple low-precision testers in parallel also enables reduction in silicon area. Further, lower clock frequencies may be required to intersect an entire node than otherwise possible.

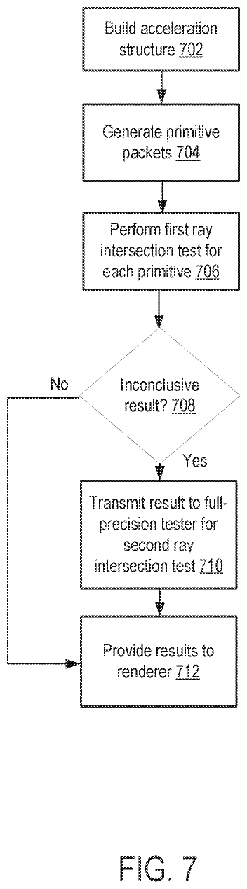

Turning now to FIG. 7, an exemplary method for ray intersection testing is described. In an implementation, an acceleration structure such as a BVH is generated (block 702). The BVH is generated to organize objects in a scene into a hierarchical tree of bounding volumes. The bounding volumes serve as representations of the geometry contained within them (e.g., triangles, boxes, etc.).

In one implementation, a plurality of prefilter nodes are generated corresponding to geometric primitives within the BVH (block 704), e.g., between internal nodes and leaf nodes of the BVH. The plurality of prefilter nodes each include quantized representations of the primitives, such as generated using a reduced-precision fixed-point arithmetic mechanism. In an example, a given prefilter node comprises individual triangles, overlapping set of triangles, or a combination of both. In one implementation, the prefilter nodes can be generated based on primitive packets storing full-precision primitives, e.g., stored in the leaf nodes of the BVH.

The triangles (or other geometric primitives) included in the prefilter nodes are tested against a ray in a first intersection test (block 706). In an implementation, the first intersection test is used as a first pass to distinguish quantized primitives that are intersected or missed definitively by a ray. Further, the first intersection test is performed simultaneously for a single ray against each quantized primitive, e.g., using reduced-precision intersection testing filters (as described in FIG. 3). The number of reduced-precision intersection testing filters can be determined based on number of quantized triangles within a prefilter node, amongst other factors.

Based on the result of the first intersection testing, it is further determined whether inconclusive results are obtained for one or more quantized primitives (conditional block 708). If no inconclusive results are obtained (conditional block 708, “no” leg), i.e., conclusive intersection results (hits or misses) are obtained for all quantized primitives that were tested, the method continues to block 712. As described at block 712, the results of the intersection tests are provided to a renderer or rendering circuitry. In an implementation, the rendering circuitry uses the result data from the intersection test to calculate the shading and lighting for a specific point on the triangle's surface. This includes evaluating the surface properties (e.g., color, texture, normal) and applying lighting models to determine how the triangle interacts with light sources in the scene. Other implementations are contemplated.

In case there are one or more inconclusive results (conditional block 708, “yes” leg), the quantized primitives for which these inconclusive results are generated are retested against the given ray by a full-precision tester for a second intersection test (block 710). In an implementation, the full-precision tester uses a floating-point mechanism and tests the ray against a given primitive using a precision that is greater than what is used for the first intersection test. Further, in an implementation, a single full-precision tester can be associated with a plurality of low-precision testers operating in parallel, such that a full-precision primitive corresponding to a quantized primitive for which an inconclusive test result is obtained during first intersection test, can be retested by the full-precision tester to definitively ascertain whether the ray hits or misses the primitive. The result of the second intersection test can then be provided to the rendering circuitry, which can use the result to render an image or a scene.

It should be emphasized that the above-described implementations are only non-limiting examples of implementations. Numerous variations and modifications will become apparent to those skilled in the art once the above disclosure is fully appreciated. It is intended that the following claims be interpreted to embrace all such variations and modifications.

What is claimed is:

1. A method comprising:
performing, in parallel, a first ray intersection test for a ray against each of a plurality of primitives, wherein the first ray intersection test is performed at a first level of precision; and
performing a second ray intersection test for the ray against one or more primitives of the plurality of primitives at a second level of precision higher than the first level of precision, responsive to the first ray intersection test generating an inconclusive hit result for the one or more primitives.

2. The method as claimed in claim 1, wherein each of the one or more primitives are tested by the second ray intersection test individually.

3. The method as claimed in claim 1, wherein the first ray intersection test is performed by first intersection test circuitry using fixed-point arithmetic and the second ray intersection test is performed by second intersection test circuitry using floating-point arithmetic.

4. The method as claimed in claim 1, further comprising:
responsive to performing the first ray intersection test for a quantized primitive:
associating a conclusive miss result with the quantized primitive responsive to the ray intersecting a two-dimensional plane outside of a boundary of the quantized primitive; and
associating a conclusive hit result with the quantized primitive responsive to the ray intersecting the two-dimensional plane inside the boundary of the quantized primitive.

5. The method as claimed in claim 1, wherein the inconclusive hit result is generated for a given primitive responsive to the first ray intersection test intersecting a plane, on which the given primitive is projected, at a location between a first boundary smaller than the given primitive and a second boundary larger than the given primitive.

6. The method as claimed in claim 5, further comprising:
computing a weighted average of vertices of a triangle using barycentric coordinates for the triangle;
identifying, using the weighted average, an intersection point at which a ray intersects with the triangle; and
calculating one or more ray parameters for the ray based at least in part on the intersection point.

7. The method as claimed in claim 1, further comprising generating the plurality of primitives by quantizing an initial representation of each primitive of the plurality of primitives to create reduced-precision compressed representations for each primitive.

8. A processor comprising:
ray tracing circuitry configured to:
simultaneously perform a first ray intersection test for a ray against each of a plurality of primitives, wherein the first ray intersection test is performed at a first level of precision; and
perform a second ray intersection test for the ray against one or more primitives of the plurality of primitives at a second level of precision higher than the first level of precision, responsive to the first ray intersection test generating an inconclusive hit result for the one or more primitives.

9. The processor as claimed in claim 8, wherein the ray tracing circuitry is configured to perform the second ray intersection test for the one or more primitives individually.

10. The processor as claimed in claim 8, wherein the first ray intersection test is performed using a first intersection test circuitry using fixed-point arithmetic and the second ray intersection test is performed using a second intersection test circuitry using floating-point arithmetic.

11. The processor as claimed in claim 8, wherein the ray tracing circuitry is configured to:
responsive to performing the first ray intersection test for a quantized primitive:
associate a conclusive miss result with the quantized primitive responsive to the ray intersecting a two-dimensional plane outside of a boundary of the quantized primitive; and
associate a conclusive hit result with the quantized primitive responsive to the ray intersecting the two-dimensional plane inside the boundary of the quantized primitive.

12. The processor as claimed in claim 8, wherein the inconclusive hit result is generated for a given primitive responsive to the first ray intersection test intersecting a plane, on which the given primitive is projected, at a location between a first boundary smaller than the given primitive and a second boundary larger than the given primitive.

13. The processor as claimed in claim 12, wherein the ray tracing circuitry is configured to:
compute a weighted average of vertices of a triangle using barycentric coordinates for the triangle;
identify, using the weighted average, an intersection point at which a ray intersects with the triangle; and
calculate one or more ray parameters for the ray based at least in part on the intersection point.

14. The processor as claimed in claim 8, wherein the inconclusive hit result is generated for a given primitive responsive to the first ray intersection test failing to generate either a conclusive miss result or a conclusive hit result.

15. A system comprising:
ray tracing circuitry comprising:
first testing circuitry configured to simultaneously perform a first ray intersection test for a ray against each of a plurality of primitives, wherein the first ray intersection test is performed at a first level of precision; and
second testing circuitry configured to perform a second ray intersection test for the ray against one or more primitives of the plurality of primitives at a second level of precision higher than the first level of precision, responsive to the first ray intersection test generating an inconclusive hit result for the one or more primitives;
a graphics processing circuit configured to render an image based on primitives of the plurality of primitives identified by either the first testing circuitry and the second testing circuitry as being intersected by the first ray.

16. The system as claimed in claim 15, wherein the inconclusive hit result corresponds to primitives which fail to generate either a conclusive miss result or a conclusive hit result.

17. The system as claimed in claim 15, wherein the first testing circuitry comprises a plurality of reduced-precision intersection testers operating on a fixed-point arithmetic and the second testing circuitry comprises one or more full-precision intersection testers operating on a floating-point arithmetic.

18. The system as claimed in claim 15, wherein the ray tracing circuitry is configured to:
responsive to the first ray intersection test for a quantized primitive:
associate a conclusive miss result with the quantized primitive responsive to the ray intersecting a two-dimensional plane outside of a boundary of the quantized primitive; and
associate a conclusive hit result with the quantized primitive responsive to the ray intersecting the two-dimensional plane inside the boundary of the quantized primitive.

19. The system as claimed in claim 18, wherein a given primitive from the plurality of primitives includes a triangle, and wherein a result of the first ray intersection test for the triangle corresponds to barycentric coordinates for the triangle.

20. The system as claimed in claim 19, wherein the ray tracing circuitry is configured to:
compute a weighted average of vertices of the triangle using the barycentric coordinates for the triangle;
identify, using the weighted average, an intersection point at which a ray intersects with the triangle; and
calculate one or more ray parameters for the ray based at least in part on the intersection point.
